(19) United States
(12) Patent Application Publication
(10) Pub. No.: US 2012/0117142 A1
(43) Pub. Date: May 10, 2012

(54) CLOUD COMPUTING SYSTEM AND DATA ACCESSING METHOD THEREOF

(75) Inventor: Ying-Chih Lu, Taipei City (TW)

(73) Assignee: INVENTEC CORPORATION, Taipei City (TW)

(21) Appl. No.: 12/982,830

(22) Filed: Dec. 30, 2010

(30) Foreign Application Priority Data
Nov. 5, 2010 (TW) 99138171

(51) Int. Cl. G06F 15/16

(52) U.S. Cl. 709/203

(57) ABSTRACT

A cloud computing system and a data accessing method thereof are provided. A memory data of a user is received in a client device. The memory data is uploaded to a personal database system in a cloud service device through the Internet. When the user wants to view the memory data, a data obtaining command is sent from the client device to the cloud service device through the Internet. After the cloud service device receives the data obtaining command, the corresponding memory data is read from the personal database system and sent to the client device through the Internet.

### CROSS-REFERENCE TO RELATED APPLICATION

This application claims the priority benefit of Taiwan application serial no. 99138171, filed on Nov. 5, 2010. The entirety of the above-mentioned patent application is hereby incorporated by reference herein and made a part of this specification.

### BACKGROUND OF THE INVENTION

1. Field of the Invention

The invention generally relates to a cloud computing mechanism, and more particularly, to a cloud computing system and a data accessing method thereof.

2. Description of Related Art

Cloud computing is a technology by which the ultra-high speed operation and extra-large storage of a server group are utilized through the Internet so that various operations can be carried out and files and data can be stored over the Internet (i.e., the enormous virtual space). Thus, it is not necessary to run software installed on personal computers or store data into local hard disk. Accordingly, data can be stored into servers on the Internet through network services, and web pages of these network services can be viewed through a web browser so that various operations can be performed through foregoing interfaces. Thereby, cloud computing technology has become one of today's major subjects in the industry.

### SUMMARY OF THE INVENTION

Accordingly, the invention is directed to a cloud computing system and a data accessing method thereof, wherein a memory data is obtained from a cloud service device according to a simple feature data.

The invention provides a cloud computing system including a cloud service device, an Internet, and a client device, wherein the client device and the cloud service device communicate with each other through the Internet. The cloud service device includes a personal database system and an operation server system. The client device receives a memory data of a user and uploads the memory data to the personal database system corresponding to the user in the cloud service device through the Internet. When the user wants to view the memory data, the client device sends a data obtaining command to the cloud service device through the Internet, wherein the data obtaining command contains a feature data. When the cloud service device receives the data obtaining command, it reads the memory data corresponding to the feature data from the personal database system through the operation server system and sends the memory data to the client device.

According to an embodiment of the invention, the cloud computing system further includes a management server system. The management server system receives an authentication data and authenticates the client device according to the authentication data. Besides, after authenticating the client device, the management server system allows the client device to connect to the cloud service device.

According to an embodiment of the invention, the management server system includes an identity recognition database, a cloud address obtaining module, an identity recognition saving module, and an identity recognition comparing module. When the identity recognition saving module receives a identity data storage command, it obtains an Internet protocol (IP) address and a connection port of the cloud service device through the cloud address obtaining module and associates and stores the IP address, the connection port, and a predetermined authentication data into the identity recognition database. Besides, the identity recognition comparing module compares the authentication data received from the client device with the predetermined authentication data stored in the identity recognition database. If the authentication data received from the client device matches the predetermined authentication data stored in the identity recognition database, the identity recognition comparing module obtains the IP address and connection port of the corresponding cloud service device from the identity recognition database so that the client device can connect to the cloud service device.

According to an embodiment of the invention, the client device includes an input module, an output module, and a connection module. The input module is configured to receive the memory data so that the memory data can be sent to the cloud service device, and the input module is also configured to receive aforementioned commands. The output module is configured to output the memory data received from the cloud service device. The connection module is configured to connect to the cloud service device.

According to an embodiment of the invention, the input module includes at least one of an image capturing unit, a voice receiving unit, and a touch control unit, and the output module includes at least one of an electronic paper, a voice output unit, and a display unit.

The invention also provides a data accessing method. A memory data of a user is received in a client device. The memory data is uploaded to a personal database system corresponding to the user in a cloud service device through an Internet. When the user wants to view the memory data, a data obtaining command is sent from the client device to the cloud service device through the Internet, wherein the data obtaining command contains a feature data. When the cloud service device receives the data obtaining command, the memory data corresponding to the feature data is read from the personal database system and sent to the client device through the Internet.

According to an embodiment of the invention, in the step of uploading the memory data to the personal database system corresponding to the user in the cloud service device through the Internet, the feature data is set as an index of the memory data.

According to an embodiment of the invention, in the data accessing method, the client device is authenticated in the cloud service device according to an authentication data received from the client device, and after the client device is authenticated, a connection between the client device and the cloud service device is established.

According to an embodiment of the invention, in the data accessing method, an identity data storage command is sent from the client device to a management server system, and a predetermined authentication data is sent from the client device to the cloud service device. When the management server system receives the identity data storage command, the predetermined authentication data is stored. In the step of storing the predetermined authentication data, an IP address and a connection port of the cloud service device are obtained, and the IP address, the connection port, and the predetermined authentication data are associated and stored into an identity recognition database.

Thereby, in the invention, data viewed by a user is stored into a cloud service device so that less storage space is used in a client device. Besides, a feature data is set as an index of a memory data stored in the cloud service device, so that the user can obtain the corresponding memory data from the cloud service device by inputting the feature data in the client device, which makes the user's operation very convenient. To be more specific, human brain offers limited memory therefore cannot hold every detail without any slip. However, human brain can remember the abstracts (for example, features, associations, and keys) of an event for a very long time. If a user remembers only some simple abstracts (for example, features and associations) but not every detail of a desired data, the user can instantly obtain the details of the data anywhere and anytime through the technique provided by the invention, just like the user has always kept all the details of the data in his mind. Thereby, the ultra-high speed operation and extra-large storage of cloud devices or services can be utilized to assist the memory of human brain, and data stored in cloud devices can be instantly obtained through the Internet via ultra-wide band (UWB).

These and other features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a cloud computing system according to a first embodiment of the invention.

FIG. 2 is a flowchart of a data accessing method according to the first embodiment of the invention.

FIG. 3 is a block diagram of a cloud computing system according to a second embodiment of the invention.

FIG. 4 is a flowchart of an identity data storage method according to the second embodiment of the invention.

FIG. 5 is a flowchart of a connection method according to the second embodiment of the invention.

FIG. 6 is a flowchart of a disconnection method according to the second embodiment of the invention.

FIG. 7 is a flowchart of a memory data storage method according to the second embodiment of the invention.

FIG. 8 is a flowchart of a memory data reading method according to the second embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

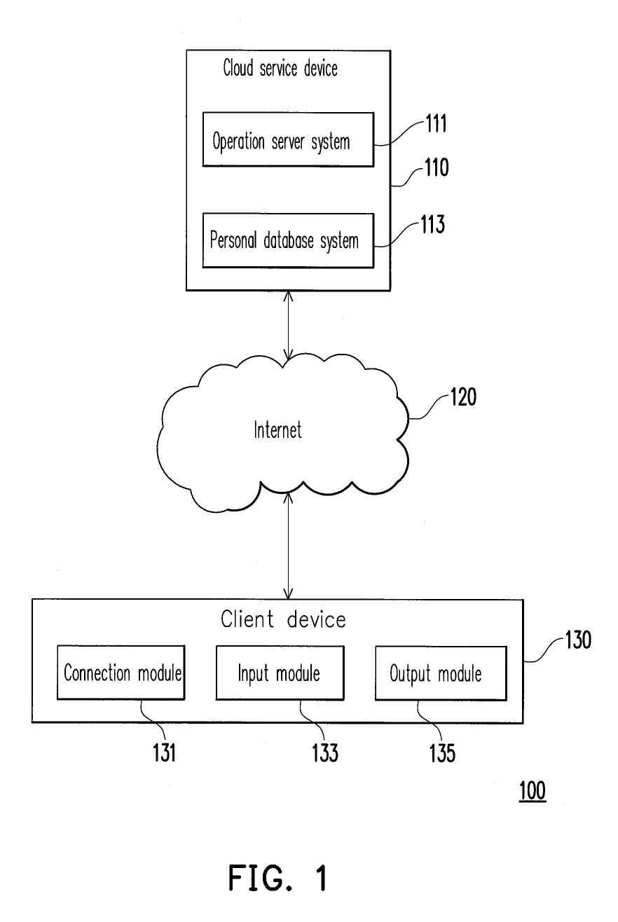

FIG. 1 is a block diagram of a cloud computing system according to the first embodiment of the invention. Referring to FIG. 1, the cloud computing system 100 includes a cloud service device 110, an Internet 120, and a client device 130. The client device 130 and the cloud service device 110 communicate with each other through the Internet 120.

The cloud service device 110 includes an operation server system 111 and a personal database system 113. The operation server system 111 includes a plurality of operation servers. The personal database system 113 contains a plurality of distributed personal databases for storing memory data viewed by users.

The client device 130 receives a memory data of a user and uploads the memory data to the personal database system 113 corresponding to the user in the cloud service device 110 through the Internet 120. For example, each user has his or her own corresponding distributed personal databases. When the user wants to view the memory data, the client device 130 sends a data obtaining command to the cloud service device 110 through the Internet 120. The data obtaining command contains a feature data corresponding to the memory data to be viewed. When the cloud service device 110 receives the data obtaining command, it reads the memory data corresponding to the feature data from the personal database system 113 through the operation server system 111 and sends the memory data to the client device 130.

In the present embodiment, the client device 130 includes a connection module 131, an input module 133, and an output module 135. The input module 133 is configured to receive a memory data so that the memory data can be sent to the cloud service device 110, and the input module 133 is configured to receive various commands. The output module 135 is configured to output the memory data received from the cloud service device 110. The connection module 131 is configured to connect to the cloud service device 110. The input module 133 includes at least one of an image capturing unit (for example, a camera or a video camera), a voice receiving unit (for example, a microphone), and a touch control unit (for example, a touch control panel or a writing board). The output module 135 includes at least one of an electronic paper, a voice output unit (for example, a speaker), and a display unit (for example, a screen or a micro-projector).

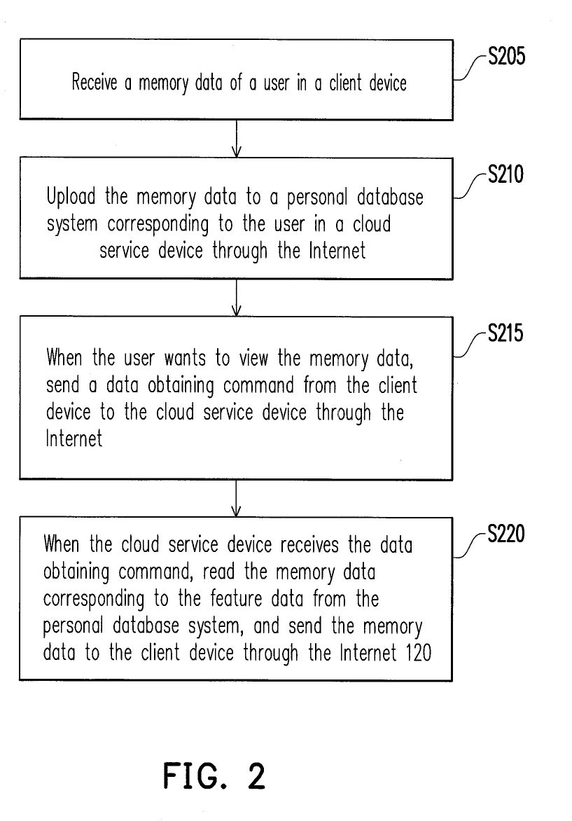

Various steps in the data accessing method will be described in detail with reference to another embodiment. FIG. 2 is a flowchart of a data accessing method according to the first embodiment of the invention. Referring to both FIG. 1 and FIG. 2, in step S205, a memory data of a user is received in the client device 130. To be specific, memory data viewed by the user is received through the input module 133. Herein the memory data may be image data obtained by using a camera, continuous image data obtained by using a video camera, or voice data recorded by using a microphone.

Then, in step S210, the memory data is uploaded to the personal database system 113 corresponding to the user in the cloud service device 110 through the Internet 120. Herein the client device 130 is comparable to a human brain and cannot contain too much data. Thus, memory data that has been viewed by the user is stored into the cloud service device 110.

In order to allow the memory data to be found conveniently, in the present embodiment, when the memory data is uploaded, a feature data is further set in the client device 130 as an index of the memory data, and the feature data and the memory data are both uploaded to the cloud service device 110. For example, the user shot videos of some show girl performances in 2010 Computer Expo and sets “2010 Computer Expo” as the feature data and an index of the audio/video files. Each memory data contains two fields, one of the fields is used for recording the index (i.e., the feature data of memory data), and the other field is used for recording the memory data itself.

Next, in step S215, when the user wants to view the memory data, a data obtaining command is sent from the client device 130 to the cloud service device 110 through the Internet 120. The data obtaining command contains the feature data of the memory data to be viewed. In the present embodiment, the client device 130 connects to the Internet 120 through a wireless connection. However, the invention is not limited thereto.

To be specific, the user issues the data obtaining command and inputs the feature data through the input module 133. For example, the user inputs the feature data by handwriting it on a writing board, by recording voice through a microphone, by touching a touch control panel, or may even brain waves in the future.

Thereafter, in step S220, when the cloud service device 110 receives the data obtaining command, the memory data corresponding to the feature data is read from the personal database system 113, and the memory data is sent to the client device 130 through the Internet 120. After that, the memory data is output through the output module 135 of the client device 130. For example, the user can obtain the corresponding memory data by simply inputting “2010 Computer Expo”. In addition, the user can also obtain the memory data corresponding to “2010 Computer Expo” by inputting “2010” or “Computer Expo”.

Because the memory data of a user is usually not very large, the time for searching the memory data in the personal database system 113 is shortened, so that the cloud service device 110 can have instant response. Besides, by setting feature data as an index, the desired memory data can be correctly obtained.

### Second Embodiment

In the present embodiment, before a client device and a cloud service device start to communicate, an identity authentication procedure is performed in order to enhance the security between the client device and the cloud service device.

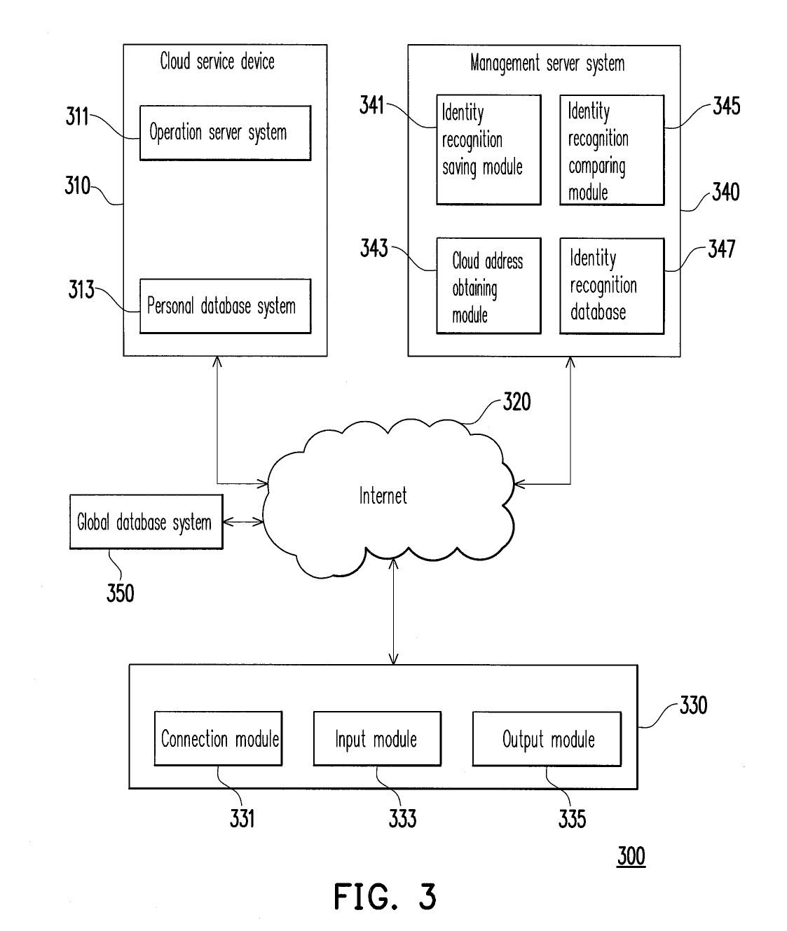

FIG. 3 is a block diagram of a cloud computing system according to the second embodiment of the invention. Referring to FIG. 3, the cloud computing system 300 includes a cloud service device 310, an Internet 320, a client device 330, and a management server system 340. The management server system 340 includes a plurality of management servers. The client device 330, the cloud service device 310, and the management server system 340 communicate with each other through the Internet 320. In the present embodiment, the management server system 340 is deployed independently. However, in other embodiments, the management server system 340 may also be disposed in the cloud service device 310. Additionally, the functions of the cloud service device 310 and the client device 330 in the present embodiment are the same as or similar to those of the cloud service device 110 and the client device 130 in the first embodiment therefore will not be described herein.

In the present embodiment, the cloud computing system 300 performs the identity authentication procedure on the client device 330 through the management server system 340. The client device 330 is allowed to connect to the cloud service device 310 only after it passes the identity authentication.

The management server system 340 includes an identity recognition saving module 341, a cloud address obtaining module 343, an identity recognition comparing module 345, and an identity recognition database 347. When the identity recognition saving module 341 receives an identity data storage command from the client device 330, it obtains an Internet protocol (IP) address and a connection port of the cloud service device 310 through the cloud address obtaining module 343 and associates and stores the IP address, the connection port, and a received predetermined authentication data into the identity recognition database 347.

The identity recognition comparing module 345 compares an authentication data received from the client device 330 with the predetermined authentication data stored in the identity recognition database 347. If the two match each other, the identity recognition comparing module 345 obtains the IP address and connection port of the corresponding cloud service device 310 from the identity recognition database 347 to allow the client device 330 to connect to the cloud service device 310.

Additionally, a voice database may be further established in the client device 330 to issue commands through voices. The voice database has three fields. One of the fields records sound wave indexes, another field records the command corresponding to each sound wave data, and the last field records description of each command, as shown in following table 1.

TABLE 1

| Sound Wave | Corresponding | |
|---|---|---|
| Indexes | Command | Description |
| sound wave data 1 | identity data storage | The client device 330 is |
| | command | about to store an |
| | | authentication data into the |
| | | management server system |
| | | 340 |
| sound wave data 2 | connection command | The client device 330 is |
| | | about to connect to the |
| | | cloud service device 310 |
| sound wave data 3 | disconnection command | The client device 330 is |
| | | about to disconnect from |
| | | the cloud service device |
| | | 310 |
| sound wave data 4 | data storage command | The client device 330 |
| | | uploads viewed memory |
| | | data to the cloud service |
| | | device 310 |
| sound wave data 5 | data obtaining command | The client device 330 is |
| | | about to obtain data from |
| | | the cloud service device |
| | | 310 |
| sound wave data 6 | feature data input | The client device 330 is |
| | command | about to input feature data |
| | | to the cloud service device |
| | | 310 |

In foregoing table 1, the command corresponding to the sound wave data 1 is an identity data storage command, and which is executed to store identity data (i.e., the client device 330 stores an authentication data into the management server system 340). The command corresponding to the sound wave data 2 is a connection command, and which is executed to establish a connection (i.e., the client device 330 connects to the cloud service device 310). The command corresponding to the sound wave data 3 is a disconnection command, and which is executed to cut off an established connection (i.e., the client device 330 disconnects from the cloud service device 310). The command corresponding to the sound wave data 4 is a data storage command, and which is executed to store memory data (i.e., the client device 330 uploads viewed memory data to the cloud service device 310). The command corresponding to the sound wave data 5 is a data obtaining command, and which is executed to read memory data (i.e., the client device 330 obtains data from the cloud service device 310). The command corresponding to the sound wave data 6 is a feature data input command, and which is executed to input corresponding feature data when memory data is stored or read.

The feature data may be used as a keyword of the memory data to be stored, or the corresponding memory data may be obtained according to the feature data. For example, a feature data is set as an index of a memory data, and the feature data and the memory data are both uploaded to the cloud service device 310, as shown in following table 2.

TABLE 2

| Feature Data | Personal Data | Data Format |
|---|---|---|
| Constitution, foreword, text | Constitution content | text |
| 2008, baseball game, photo | image file | photo |
| 2010, Taipei, speech, sound | audio file | audio |
| 2009, Taipei Computer Expo, | video file | video |
| photography, video | | |

Foregoing table 2 includes three fields. One of the fields records the feature data, another field records personal data, and the last field records data formats. Taking the Constitution content (the data format thereof is text) as an example, the corresponding feature data thereof may be at least one of the “Constitution”, “foreword”, and “text”.

Below, the communication between the cloud service device 310, the client device 330, and the management server system 340 will be described in detail with reference to the cloud computing system 300.

Before establishing the connection between the client device 330 and the cloud service device 310, an identity authentication procedure is first executed in order to ensure the security of the connection. Besides, a predetermined authentication data is set up in the management server system 340.

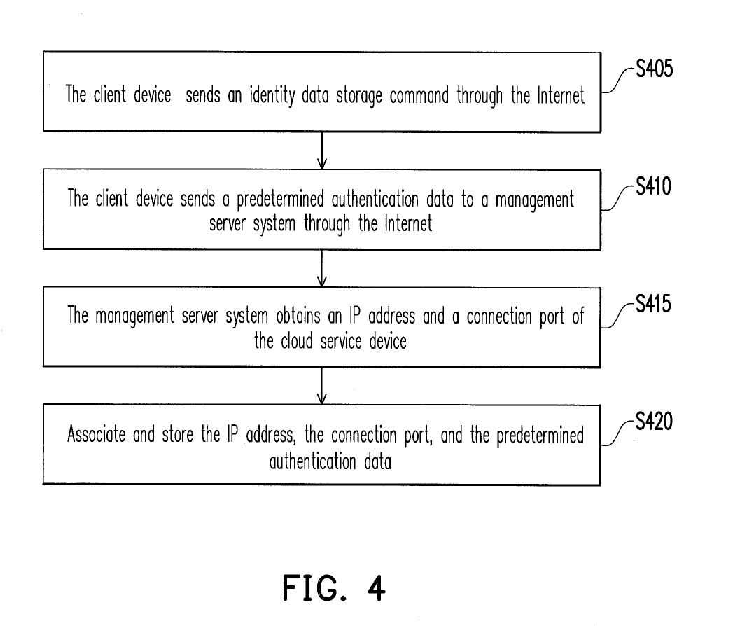

FIG. 4 is a flowchart of an identity data storage method according to the second embodiment of the invention. Referring to both FIG. 3 and FIG. 4, in step S405, the client device 330 sends an identity data storage command to the management server system 340 through the Internet 320.

Then, in step S410, the client device 330 sends a predetermined authentication data to the management server system 340 through the Internet 320. The input module 335 includes a fingerprint input unit. The input module 335 obtains a fingerprint graph data of the user through the fingerprint input unit and then converts the fingerprint graph data into a digital fingerprint data by performing a digital conversion procedure. Thereafter, the digital fingerprint data is sent to the management server system 340 through the Internet 320.

After receiving the identity data storage command and the predetermined authentication data (for example, the digital fingerprint data), in step S415, the management server system 340 obtains an IP address and a connection port of the cloud service device 310. The identity recognition saving module 341 obtains the IP address and the connection port of the cloud service device 310 through the cloud address obtaining module 343.

After obtaining the IP address and the connection port of the cloud service device 310, in step S420, the identity recognition saving module 341 in the management server system 340 associates and stores the IP address, the connection port, and the predetermined authentication data into the identity recognition database 347.

For example, the identity recognition database 347 has three fields. One of the fields records the digital fingerprint data, another field records the IP address of the cloud service device, and the last field records the connection port of the cloud service device, as shown in following table 3.

TABLE 3

| | IP Address of Cloud | Connection Port of Cloud |
|---|---|---|
| Digital Fingerprint Data | Service Device | Service Device |
| digital fingerprint data 1 | 210.6.10.10 | 65535 |
| digital fingerprint data 2 | 210.6.10.10 | 65534 |
| . . . | . . . | . . . |

After setting up the predetermined authentication data in the identity recognition database 347, the client device 330 needs to pass the identity authentication of the management server system 340 before it connects to the cloud service device 310

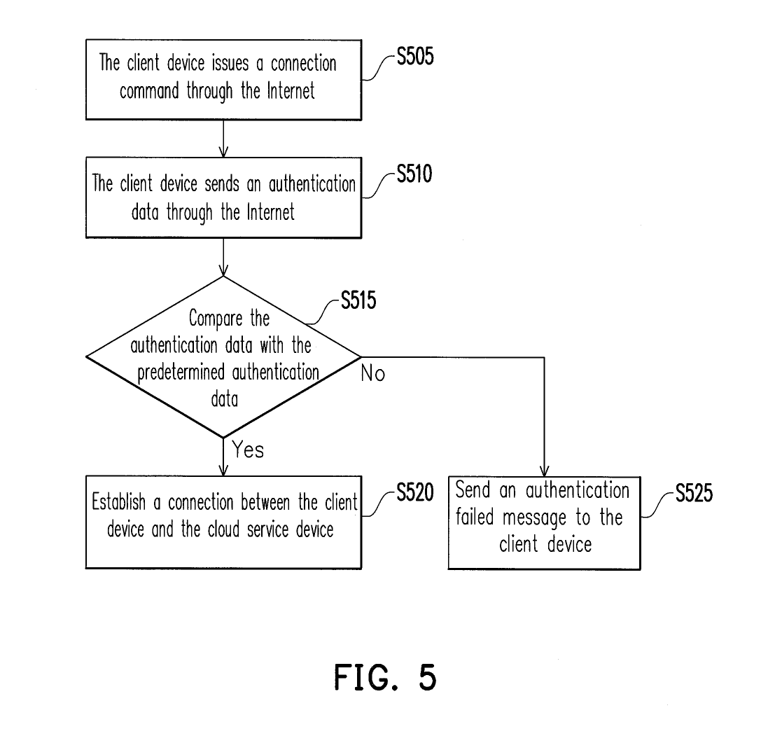

FIG. 5 is a flowchart of a connection method according to the second embodiment of the invention. Referring to both FIG. 3 and FIG. 5, in step S505, the client device 330 issues a connection command through the input module 333 and then sends the connection command to the management server system 340 through the Internet 320. Then, in step S510, the client device 330 inputs an authentication data (for example, obtains the fingerprint of a user by using a fingerprint input unit) through the input module 333 and sends the authentication data to the management server system 340 through the Internet 320. After receiving the connection command and the authentication data, in step S515, the management server system 340 compares the authentication data with the predetermined authentication data through the identity recognition comparing module 345. If the authentication data matches the predetermined authentication data, in step S520, a connection is established between the client device 330 and the cloud service device 310. Namely, if the authentication data is the same as the predetermined authentication data, an IP address and a connection port of the cloud service device 310 corresponding to the predetermined authentication data is obtained and sent to the client device 330. After receiving the IP address and the connection port of the cloud service device 310, the client device 330 connects to the cloud service device 310 through a connection module 331. Contrarily, if the authentication data does not match the predetermined authentication data, in step S525, the management server system 340 sends an authentication failed message to the client device 330.

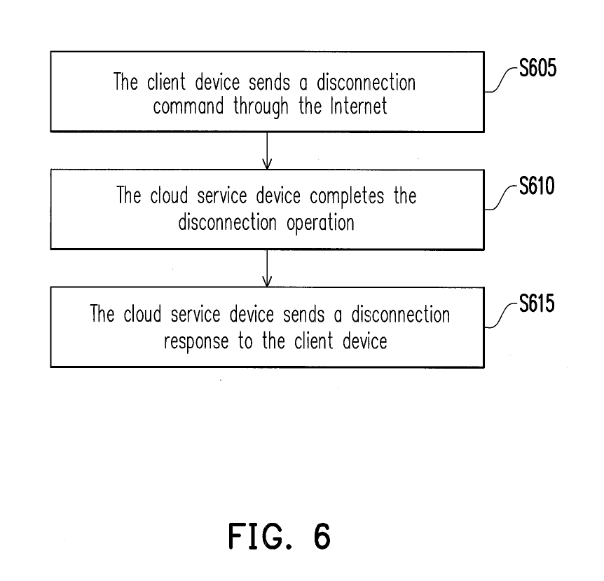

After the connection is established, if the user wants to leave the connection, the user can issue a disconnection command through the input module 333 of the client device 330. FIG. 6 is a flowchart of a disconnection method according to the second embodiment of the invention. Referring to both FIG. 3 and FIG. 6, in step S605, the client device 330 sends a disconnection command through the Internet 320. Then, in step S610, the cloud service device 310 completes the disconnection operation. Thereafter, in step S615, the cloud service device 310 sends a disconnection response to the client device 330.

After the connection between the cloud service device 310 and the client device 330 is established, the user can upload viewed memory data to the cloud service device 310.

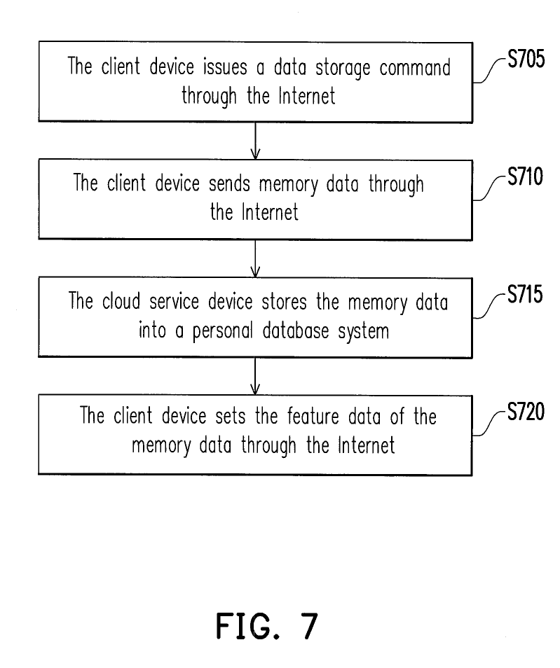

FIG. 7 is a flowchart of a memory data storage method according to the second embodiment of the invention. Referring to both FIG. 3 and FIG. 7, in step S705, the client device 330 issues a data storage command through the input module 333 and sends the data storage command to the cloud service device 310 through the Internet 320. Then, in step S710, the client device 330 sends memory data to the cloud service device 310 through the Internet 320. Thereafter, in step S715, the cloud service device 310 stores the memory data into a personal database system 313 through an operation server system 311. Besides, in step S720, the client device 330 sets the feature data of the memory data through the Internet 320 and stores the feature data into the personal database system 313. For example, the client device 330 issues a feature data input command through the input module 333 and sets the feature data of the memory data through the Internet 320.

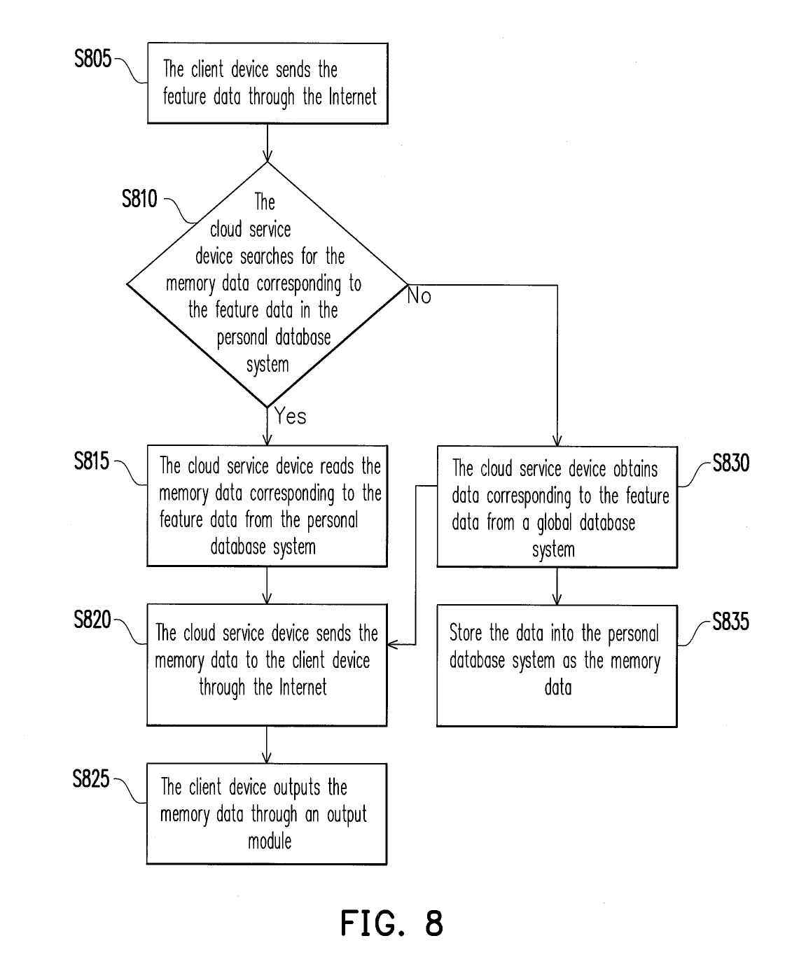

Accordingly, when the user wants to view the memory data, the user can issue a data obtaining command through the input module 333 of the client device 330. FIG. 8 is a flowchart of a memory data reading method according to the second embodiment of the invention. Referring to both FIG. 3 and FIG. 8, in step S805, the client device 330 sends the feature data through the Internet 320. For example, the client device 330 first issues a data obtaining command through the input module 333 and then issues a feature data input command through the input module 333 to send the feature data to the cloud service device 310.

Next, in step S810, the cloud service device 310 searches for the memory data corresponding to the feature data in the personal database system 313 through the operation server system 311. If the memory data corresponding to the feature data is found in the personal database system 313, in step S815, the cloud service device 310 reads the memory data corresponding to the feature data from the personal database system 313. After that, in step S820, the cloud service device 310 sends the memory data to the client device 330 through the Internet 320. In step S825, the client device 330 outputs the memory data through an output module 335.

If the memory data corresponding to the feature data is not found in the personal database system 313, in step S830, the cloud service device 310 obtains data corresponding to the feature data from a global database system 350. In step S835, the data is stored into the personal database system 313 as the memory data. Namely, even data that is not viewed by the user can be searched in the global database system 350.

Additionally, in order to make the application of the cloud computing system 300 more practical, the client device 330 can be designed as a glass-type electronic device and made comparable to a human brain. For example, an image capturing device may be disposed in the glass-type electronic device for capturing objects seen by the user and sending memory data to the cloud service device 310. Besides, a voice input module may be disposed in the glass-type electronic device such that commands can be issued through voice input. Moreover, the obtained memory data may be displayed on the glass lenses.

Additionally, various commands may be issued through voice input by using the input module 333, and each command may be corresponding to multiple keywords. When the user inputs one of the keywords, a command corresponding to the keyword is issued. For example, the keywords corresponding to the identity data storage command include “store” and “establish”. However, this is only an example but not intended to limit the scope of the invention.

In summary, in the invention, data viewed by a user is stored into a cloud service device as text, graphs, images, photos, and voices, so that less storage space is used in a client device. Besides, a feature data is set as an index of each memory data stored in the cloud service device, so that the user can obtain the corresponding memory data from the cloud service device by inputting the feature data in the client device. By obtaining the corresponding data from the cloud service device by using simply feature data, the operation of the user is made very convenient. In other words, in the invention, the ultra-high speed operation and extra-large storage of cloud devices or services are utilized to assist the memory of human brain, and data stored in the cloud devices is instantly obtained through ultra-wide band (UWB).

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A cloud computing system, comprising:
a cloud service device, comprising a personal database system and an operation server system;
an Internet; and
a client device, for receiving a memory data of a user and uploading the memory data to the personal database system corresponding to the user in the cloud service device through the Internet;
wherein when the user wants to view the memory data, the client device sends a data obtaining command to the cloud service device through the Internet, wherein the data obtaining command comprises a feature data;
when the cloud service device receives the data obtaining command, the operation server system reads the memory data corresponding to the feature data from the personal database system and sends the memory data to the client device.

2. The cloud computing system according to claim 1 further comprising:
a management server system, for receiving an authentication data, authenticating the client device according to the authentication data, and allowing the client device to connect to the cloud service device after authenticating the client device.

3. The cloud computing system according to claim 2, wherein the client device comprises:
an input module, for receiving the memory data to send the memory data to the cloud service device, and for receiving the data obtaining command;
an output module, for outputting the memory data received from the cloud service device; and
a connection module, for connecting to the cloud service device.

4. The cloud computing system according to claim 2, wherein the management server system comprises:
an identity recognition database;
a cloud address obtaining module, for obtaining an Internet protocol (IP) address and a connection port of the cloud service device;
an identity recognition saving module, for obtaining the IP address and the connection port of the cloud service device through the cloud address obtaining module and associating and storing the IP address, the connection port, and a received predetermined authentication data into the identity recognition database when an identity data storage command is received; and
an identity recognition comparing module, for comparing the authentication data received from the client device with the predetermined authentication data stored in the identity recognition database, and for obtaining the IP address and the connection port of the cloud service device from the identity recognition database when the authentication data received from the client device matches the predetermined authentication data stored in the identity recognition database to allow the client device to connect to the cloud service device.

5. The cloud computing system according to claim 1, wherein the client device comprises:
an input module, for receiving the memory data to send the memory data to the cloud service device, and for receiving the data obtaining command;
an output module, for outputting the memory data received from the cloud service device; and
a connection module, for connecting to the cloud service device.

6. The cloud computing system according to claim 5, wherein the input module comprises at least one of an image capturing unit, a voice receiving unit, and a touch control unit, and the output module comprises at least one of an electronic paper, a voice output unit, and a display unit.

7. The cloud computing system according to claim 1, further comprising:
a management server system, for receiving an authentication data, authenticating the client device according to the authentication data, and allowing the client device to connect to the cloud service device after authenticating the client device, and the management server system comprising:
an identity recognition database;
a cloud address obtaining module, for obtaining an Internet protocol (IP) address and a connection port of the cloud service device;
an identity recognition saving module, for obtaining the IP address and the connection port of the cloud service device through the cloud address obtaining module and associating and storing the IP address, the connection port, and a received predetermined authentication data into the identity recognition database when an identity data storage command is received; and
an identity recognition comparing module, for comparing the authentication data received from the client device with the predetermined authentication data stored in the identity recognition database, and for obtaining the IP address and the connection port of the cloud service device from the identity recognition database when the authentication data received from the client device matches the predetermined authentication data stored in the identity recognition database to allow the client device to connect to the cloud service device;
wherein the client device comprises:
an input module, for receiving the memory data to send the memory data to the cloud service device, and for receiving the data obtaining command, wherein the input module comprises at least one of an image capturing unit, a voice receiving unit, and a touch control unit;
an output module, for outputting the memory data received from the cloud service device, wherein the output module comprises at least one of an electronic paper, a voice output unit, and a display unit; and
a connection module, for connecting to the cloud service device.

8. A data accessing method, comprising:
receiving a memory data of a user in a client device;
uploading the memory data to a personal database system corresponding to the user in a cloud service device through an Internet;
when the user wants to view the memory data, sending a data obtaining command from the client device to the cloud service device through the Internet, wherein the data obtaining command comprises a feature data; and
when the cloud service device receives the data obtaining command, reading the memory data corresponding to the feature data from the personal database system and sending the memory data to the client device through the Internet.

9. The data accessing method according to claim 8, wherein the step of uploading the memory data to the personal database system corresponding to the user in the cloud service device through the Internet comprises:
setting the feature data as an index of the memory data.

10. The data accessing method according to claim 8 further comprising:
authenticating the client device in the cloud service device according to an authentication data received from the client device; and
after authenticating the client device, establishing a connection between the client device and the cloud service device.

11. The data accessing method according to claim 8 further comprising:
sending an identity data storage command from the client device to a management server system, and sending a predetermined authentication data from the client device to the cloud service device; and
storing the predetermined authentication data when the management server system receives the identity data storage command.

12. The data accessing method according to claim 11, wherein the step of storing the predetermined authentication data when the management server system receives the identity data storage command comprises:
obtaining an IP address and a connection port of the cloud service device; and
associating and storing the IP address, the connection port, and a received predetermined authentication data into an identity recognition database.

13. A data accessing method, comprising:
sending an identity data storage command from the client device to a management server system, and sending a predetermined authentication data from the client device to the cloud service device;
storing the predetermined authentication data when the management server system receives the identity data storage command, comprises:
obtaining an IP address and a connection port of the cloud service device; and
associating and storing the IP address, the connection port, and a received predetermined authentication data into an identity recognition database;
authenticating the client device in the cloud service device according to an authentication data received from the client device;
after authenticating the client device, establishing a connection between the client device and the cloud service device;
receiving a memory data of a user in a client device;
uploading the memory data to a personal database system corresponding to the user in a cloud service device through an Internet, and setting the feature data as an index of the memory data;
when the user wants to view the memory data, sending a data obtaining command from the client device to the cloud service device through the Internet, wherein the data obtaining command comprises a feature data; and
when the cloud service device receives the data obtaining command, reading the memory data corresponding to the feature data from the personal database system and sending the memory data to the client device through the Internet.
